(19) United States
(12) Patent Application Publication
(10) Pub. No.: US 2011/0101849 A1
(43) Pub. Date: May 5, 2011

(54) PLASMA DISPLAY PANEL

(76) Inventors: Hyun-Chul Kim, Yongin-si (KR); Eui-Jeong Hwang, Yongin-si (KR); Gi-Young Kim, Yongin-si (KR); Sang-Hyuck Ahn, Yongin-si (KR); Sang-Ho Jeon, Yongin-si (KR); Seung-Hyun Son, Yongin-si (KR); Bok-Chun Yun, Yongin-si (KR); Sil-Keun Jeong, Yongin-si (KR); Sung-Hee Cho, Yongin-si (KR); Myoung-Sup Kim, Yongin-si (KR); Hye-Jung Lee, Yongin-si (KR); Sung-Soo Kim, Yongin-si (KR); Mun-Ho Nam, Yongin-si (KR); Hyoung-Bin Park, Yongin-si (KR); Jung-Min Kim, Yongin-si (KR); Hyeon-Seok Kim, Yongin-si (KR); Sung-Hyun Choi, Yongin-si (KR)

(21) Appl. No.: 12/870,771

(22) Filed: Aug. 27, 2010

(30) Foreign Application Priority Data
Oct. 30, 2009 (KR) 10-2009-0104303

(51) Int. Cl. H01J 17/49

(52) U.S. Cl. 313/485

(57) ABSTRACT

A plasma display panel (PDP) includes: a front substrate facing a rear substrate; first and second discharge enhancement layers disposed between the front and rear substrates and arranged on both sides of a main discharge space; first and second barrier ribs respectively formed on the first and second discharge enhancement layers and defining first and second asymmetric stepped spaces along with the first and second discharge enhancement layers; a scan electrode and a common electrode inducing a mutual discharge in the main discharge space; an address electrode generating an address discharge along with the scan electrode and extending in a direction to intersect the scan electrode; a phosphor layer formed in at least the main discharge space; and a discharge gas filled in the main discharge space and the first and second stepped spaces. Accordingly, the PDP having high efficiency may operate with low power and obtain high luminous brightness.

### CROSS-REFERENCE TO RELATED APPLICATION

This application claims priority to and the benefit of Korean Patent Application No. 10-2009-0104303, filed Oct. 30, 2009 in the Korean Intellectual Property Office, the disclosure of which is incorporated herein in its entirety by reference.

### BACKGROUND OF THE INVENTION

1. Field of the Invention

One or more embodiments of the present invention relate to a plasma display panel (PDP), and more particularly, to a high efficiency PDP that may operate with low power and obtain high luminous brightness.

2. Description of the Related Art

In general, plasma display panels (PDPs) are flat panel displays that excite phosphors using ultraviolet (UV) rays generated by a plasma discharge and create an image using visible light generated from the excited phosphors. PDPs are generally configured in such a manner that barrier ribs define a plurality of discharge cells. The barrier ribs are interposed between an upper substrate on which discharge electrodes are arranged and a lower substrate on which address electrodes are arranged to enable the upper substrate and the lower substrate to face each other. A discharge gas is injected between the upper substrate and the lower substrate. A discharge voltage is applied between the discharge electrodes to excite phosphors coated in the discharge cells, and create an image using visible light generated by the excited phosphors.

General PDPs have a problem when a large portion of a phosphor layer is attached to side surfaces of the barrier ribs. Since flowable phosphor paste sags and flows down from the side surfaces of the barrier ribs, the phosphor layer is not formed with a sufficiently large and uniform thickness. Such general PDPs have another problem in that since visible light generated by the excited phosphors is not output upward but output in a lateral direction from side surfaces of the barrier ribs, visible light extraction efficiency is low. Such general PDPs have another problem in that since bottom surfaces of the discharge cells on which the phosphors are concentrated are relatively far from the front substrate on which the discharge electrodes are arranged, a sufficient amount of UV light does not reach the phosphors, thereby failing to effectively excite the phosphors. Such general PDPs have another problem in that since an address discharge occurs along a long discharge path corresponding to the height of a discharge cell, an address driving voltage is high and a sufficient voltage margin is not obtained.

### SUMMARY OF THE INVENTION

One or more embodiments of the present invention include a high efficiency plasma display panel (PDP) that may operate with low power and obtain high luminous brightness.

One or more embodiments of the present invention include a PDP that may reduce trapped air bubbles in a phosphor layer and improve ultraviolet (UV)-visible light conversion efficiency by forming the phosphor layer with uniform thickness.

According to one or more embodiments of the present invention, a PDP includes: a front substrate and a rear substrate facing each other; first and second discharge enhancement layers disposed between the front substrate and the rear substrate and arranged on both sides of a main discharge space; first and second barrier ribs respectively formed on the first and second discharge enhancement layers and defining first and second stepped spaces, which are asymmetric, along with the first and second discharge enhancement layers; a scan electrode and a common electrode inducing a mutual discharge in the main discharge space; an address electrode generating an address discharge along with the scan electrode and extending in a direction to intersect the scan electrode; a phosphor layer formed in at least the main discharge space; and a discharge gas filled in the main discharge space and the first and second stepped spaces.

According to an aspect of the invention, the first stepped space may be defined by the first discharge enhancement layer and the first barrier rib which are disposed on one side of the main discharge space, and the second stepped space may be defined by the second discharge enhancement layer and the second barrier rib which are disposed on the other side of the main discharge space.

According to an aspect of the invention, the first width W1 between the first barrier rib defining the first stepped space and an end of the first discharge enhancement layer and a second width W2 between the second barrier rib defining the second stepped space and an end of the second discharge enhancement layer may satisfy a relationship of W1>W2.

According to an aspect of the invention, the first and second stepped spaces formed on both sides of the main discharge space may form one unit cell by being connected to the main discharge space.

According to an aspect of the invention, the first stepped space, the main discharge space, and the second stepped space forming the one unit cell may be repeatedly formed in the same order from one end to the other end of the PDP.

According to an aspect of the invention, a non-discharge space in which no discharge occurs may be formed between adjacent unit cells.

According to an aspect of the invention, the PDP may further include an external-light absorbing layer formed over the non-discharge space.

According to an aspect of the invention, the PDP may further include a third barrier rib disposed between the front substrate and the rear substrate and extending in a direction to cross the first and second barrier ribs.

According to an aspect of the invention, the phosphor layer may be expanded from the main discharge space to the first and second stepped spaces.

Additional aspects and/or advantages of the invention will be set forth in part in the description which follows and, in part, will be obvious from the description, or may be learned by practice of the invention.

According to one embodiment of the present invention, a plasma display panel includes: a plurality of first barrier ribs and a plurality of second barrier ribs; a plurality of unit cells configured to emit light, each of the unit cells being located between a corresponding one of the first barrier ribs and a corresponding one of the second barrier ribs, the unit cells being filled with a discharge gas; a plurality of pairs of scan and common electrodes, each of the pairs being configured to induce a discharge in corresponding ones of the unit cells; a plurality of discharge enhancement layers, wherein at least one of the discharge enhancement layers extends across a portion of at least one of the unit cells and forms a raised area which is raised above a lower area of the at least one of the unit cells; and a plurality of phosphor layers in the unit cells, the phosphor layers being configured to emit light in accordance with the induced discharge.

### BRIEF DESCRIPTION OF THE DRAWINGS

These and/or other aspects and advantages of the invention will become apparent and more readily appreciated from the following description of the embodiments, taken in conjunction with the accompanying drawings of which:

FIG. 1 is an exploded perspective view of a plasma display panel (PDP) according to an embodiment of the present invention;

FIG. 2 is an exploded perspective view illustrating a part of the PDP of FIG. 1;

FIG. 3 is a vertical cross-sectional view taken along line III-III of FIG. 1;

FIG. 4 is a perspective view for explaining a process of applying phosphors;

FIG. 5 is an exploded perspective view of a PDP according to an embodiment of the present invention; and

FIG. 6 is a vertical cross-sectional view taken along line VI-VI of FIG. 5.

### DETAILED DESCRIPTION OF THE INVENTION

Reference will now be made in detail to the present embodiments of the present invention, examples of which are illustrated in the accompanying drawings, wherein like reference numerals refer to the like elements throughout. The embodiments are described below in order to explain the present invention by referring to the figures.

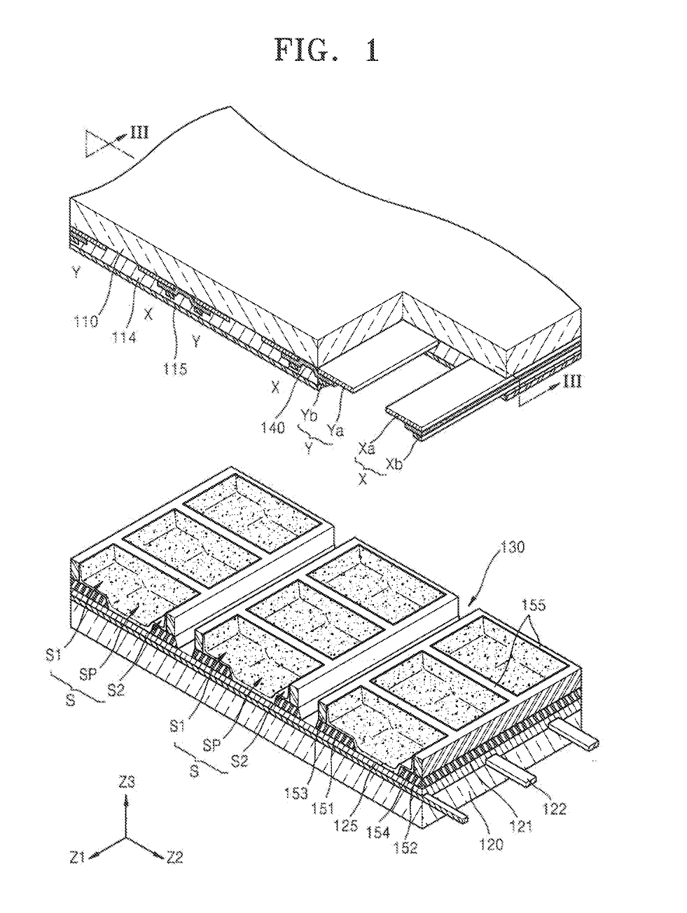

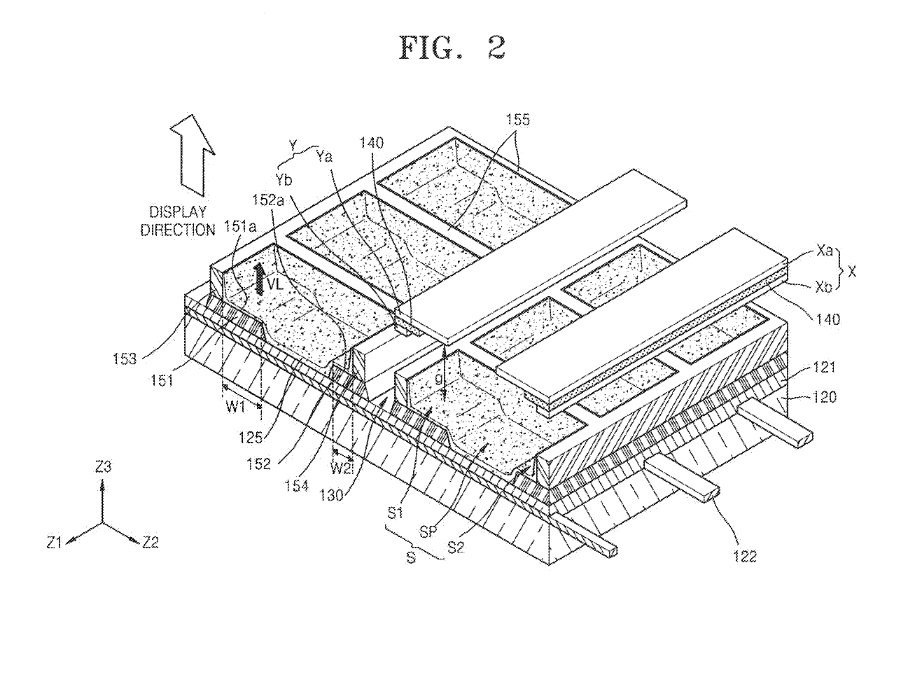

FIG. 1 is an exploded perspective view of a plasma display panel (PDP) according to an embodiment of the present invention. FIG. 2 is an exploded perspective view illustrating a part of the PDP of FIG. 1. Referring to FIGS. 1 and 2, the PDP includes a front substrate 110 facing a rear substrate 120 facing. The front substrate 110 is spaced apart from the rear substrate 120 by an interval. First and second discharge enhancement layers 151 and 152 are disposed on the rear substrate 120 and extend in a Z1 direction. First and second barrier ribs 153 and 154 are disposed on the rear substrate 120. Common electrodes X and scan electrodes Y are disposed on the front substrate 110.

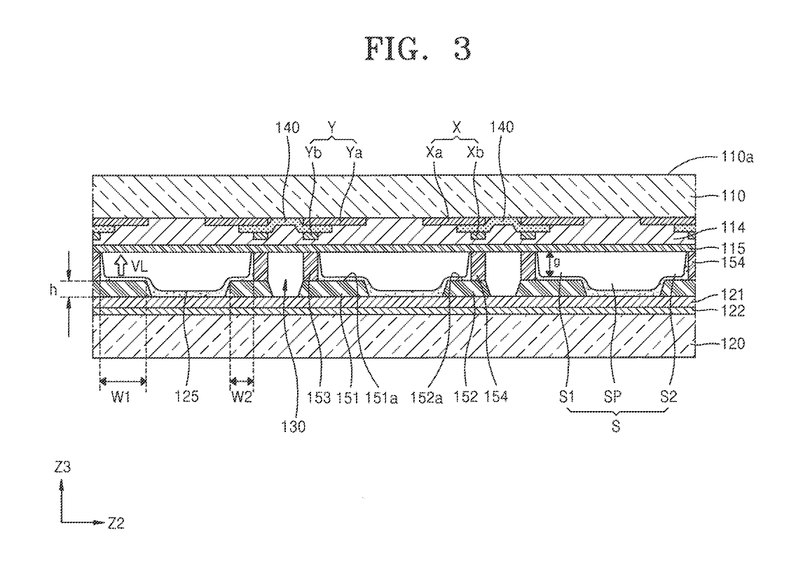

FIG. 3 is a vertical cross-sectional view taken along line III-III of FIG. 1. Referring to FIG. 3, the first and second discharge enhancement layers 151 and 152 have relatively large widths. Adjacent first and second discharge enhancement layers 151 and 152 form one pair with a main discharge space SP therebetween. The first and second barrier ribs 153 and 154 having relatively small widths are disposed on the first and second discharge enhancement layers 151 and 152. Since the first barrier rib 153 having the small width is stacked on the first discharge enhancement layer 151 having the large width, a first stepped space 51 is defined by the first discharge enhancement layer 151 and the first barrier rib 153. Likewise, since the second barrier rib 154 having the small width is stacked on the second discharge enhancement layer 152 having the large width, a second stepped space S2 is defined by the second discharge enhancement layer 152 and the second barrier rib 154. For example, the first and second stepped spaces 51 and S2 formed on both sides of the main discharge space SP may form one unit cell S. However, it is understood that the unit cell S need not include two stepped spaces 51 and S2, and can include only one stepped space or other numbers of stepped spaces.

As shown and while not required in all aspects, a non-discharge space 130 is formed between adjacent unit cells S. In detail, the non-discharge space 130 is shown formed between the first and second barrier ribs 153 and 154 defining adjacent unit cells S. The non-discharge space 130 acts as an impurity gas flow path and reduces flow resistance during a process of exhausting an impurity gas remaining in the PDP. An external-light absorbing layer 140 is shown formed over the non-discharge space 130. The external-light absorbing layer 140 includes a black pigment and a black coloring material, and improves the visibility of an image by improving contrast characteristics. However, the external-light absorbing layer 140 is optional, not mandatory.

The common electrodes X and the scan electrodes Y are disposed on the front substrate 110. Adjacent pairs of common and scan electrodes X and Y form one pair, causing a display discharge in one unit cell S. The shown common electrode X and the scan electrode Y respectively include transparent electrodes Xa and Ya formed of light transmitting conductive materials, and bus electrodes Xb and Yb electrically contacting the transparent electrodes Xa and Ya and forming power supply lines.

The common electrode X and the scan electrode Y are covered by a dielectric layer 114 so as to be protected from direct collisions with charged particles participating in a discharge. The shown dielectric layer 114 is covered and protected by a protective layer 115 formed of, for example, an MgO thin film.

The address electrodes 122 are disposed on the rear substrate 120. Each of the address electrodes 122 performs an address discharge along with the scan electrode Y. A voltage applied between the scan electrode Y and the address electrode 122 helps to form an electric field high enough to fire a discharge in a unit cell S through the dielectric layer 114 covering the scan electrode Y and the first discharge enhancement layer 151 disposed on the address electrode 122. At this time, an address discharge may be generated when the dielectric layer 114 covering the scan electrode Y and the first discharge enhancement layer 151 disposed on the address electrode 122 form facing discharge surfaces.

The bus electrode Yb of the scan electrode Y on which an electric field is concentrated is shown disposed over the first discharge enhancement layer 151 so as to form the facing discharge surfaces. That is, the bus electrode Yb faces a top surface 151a of the first discharge enhancement layer 151 with the first and second barrier ribs 153 and 154 therebetween. Also, as shown in FIG. 3, the bus electrode Yb may also be disposed over the first barrier rib 153 so as to prevent extraction of light from being inhibited by the bus electrode Yb, which usually is formed of an opaque metal material.

While a general PDP performs a discharge between scan electrodes Y and address electrodes 122 through a long discharge path between a front substrate 110 and a rear substrate 120, since the PDP of FIG. 1 performs an address discharge using the first discharge enhancement layer 151 projecting toward the scan electrode Y to have a height h, an address discharge path is reduced to a length corresponding to a discharge gap g between the first discharge enhancement layer 151 and the dielectric layer 114. This achieves a higher driving efficiency than the general PDP.

While not required in all aspects, the shown address electrode 122 is covered by a dielectric layer 121 that is formed on the rear substrate 120. The first and second discharge enhancement layers 151 and 152 are formed on a flat surface of the dielectric layer 121.

A phosphor layer 125 is formed in the main discharge space Sp. Specifically, the phosphor layer 125 is shown formed on the dielectric layer 125 between the first and second discharge enhancement layers 151 and 152. A plurality of the phosphor layers 125 generate different colors of visible light, for example, red (R), green (G), and blue (B) visible light, by interacting with ultraviolet (UV) rays generated as a result of a display discharge.

The phosphor layer 125 is not limited by the main discharge space Sp, and may be expanded to the first and second stepped spaces 51 and S2 as shown. In detail, the phosphor layer 125 covers part of the first and second discharge enhancement layers 151 and 152 defining the first and second stepped spaces 51 and S2. Also, as shown in FIG. 3, the phosphor layer 125 may be expanded to top surfaces 151a and 152a of the first and second discharge enhancement layers 151 and 152, and even to side surfaces of the first and second barrier ribs 153 and 154. As such, the phosphor layer 125 need not only be in the main discharge space Sp. Further, while shown as being on both the first and second stepped spaces S1 and S2, the phosphor layer 125 need not be on both of the first and second stepped spaces S1 and S2.

The phosphor layer 125 formed on the top surfaces 151a and 152a of the first and second discharge enhancement layers 151 and 152 may be effectively excited by the common electrode X and the scan electrode Y, which are near to the phosphor layer 125, thereby causing a display discharge. Also, the phosphor layer 125 formed on the top surfaces 151a and 152a is disposed near to the front substrate 110 having a display surface 110a to face the front substrate 110 in a display direction (referred to as a Z3 direction). Accordingly, the visible light VL output from the phosphor layer 125 disposed on the first and second discharge enhancement layers 151 and 152 may be readily emitted to the outside of the PDP, thereby improving visible light extraction efficiency.

The first and second stepped spaces S1 and S2 are formed on left and right sides of the main discharge space Sp. The shown first stepped space S1 formed on one side of the main discharge space SP and the second stepped space S2 formed on the other side of the main discharge space SP are asymmetric. Specifically, a first width W1 is between the first barrier rib 153 defining the first stepped space S1 and an end of the first discharge enhancement layer 151. A second width W2 is between the second barrier rib 154 defining the second stepped space S2 and an end of the second discharge enhancement layer 152. W1 and W2 are different from each other and satisfy a relationship of W1>W2. The first stepped space S1, the main discharge space Sp, and the second stepped space S2 forming each unit cell S are repeatedly formed in the same order in one direction (referred to as a Z2 direction) from one end to the other end of the PDP. This is because since a process of applying phosphors is performed in the Z2 direction, air bubbles trapped in the phosphor layer 125 may be reduced and the phosphor layer 125 may be uniformly formed.

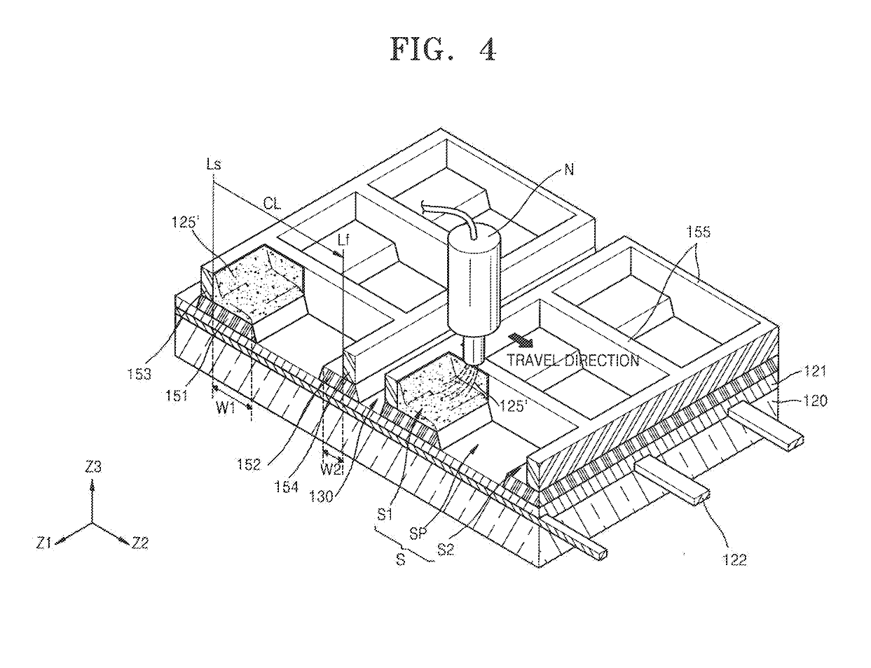

FIG. 4 is a perspective view for explaining a process of applying phosphors 125′. Referring to FIG. 4, the phosphors 125′ are in a paste form and may be continuously applied to the first stepped space S1, the main discharge space Sp, and the second stepped space S2 arranged in the Z2 direction as a spray nozzle N travels from one end to the other end of the PDP. The phosphors 125′ are ejected downward from the spray nozzle N and are inclined to a side opposite to a side toward which the spray nozzle travels in the Z2 direction. Accordingly, the phosphors 125′ are heavily accumulated on the first discharge enhancement layer 151, which is a starting position Ls of a coating area CL of each unit cell S. The phosphors 125′ are subsequently subjected to a thermal process to flow toward the second discharge enhancement layer 152, which is an ending position Lf of the coating area CL, thereby enabling the phosphors 125′ to be uniformly applied. That is, the phosphors 125′ may be stably accumulated on a portion of the first discharge enhancement layer 151 having the first width W1 that is relatively large, and then may be expanded to a portion of the second discharge enhancement layer 152 having the second width W2 that is relatively small through the thermal process.

Air bubbles trapped in the phosphors 125′ or escaping from the phosphors 125′ that are being hardened are efficiently discharged by stably accumulating the phosphors 125′ on the portion of the first discharge enhancement layer 151 having the first width W1. The phosphors 125′ are then expanded to all other parts of the unit cell S, thereby reducing trapped air bubbles remaining in the phosphors 125′. Also, since the phosphors 125′ are expanded to the portion of the second discharge enhancement layer 152 having the second width W2 that is relatively small through a thermal process after being applied to the portion of the first discharge enhancement layer 151 having the first width W1, the phosphor layer 125 may be uniformly formed.

The shown PDP of FIG. 1 further includes a third barrier rib 155 extending in the Z2 direction to cross the first and second barrier ribs 153 and 154. Each substantially rectangular unit cell S may be defined by the third barrier rib 155 and the first and second barrier ribs 153 and 154.

A discharge gas is injected into the unit cell S. The discharge gas may be a multi-element gas in which xenon (Xe), krypton (Kr), helium (He), neon (Ne), and the like capable of providing UV rays through discharge excitement are mixed in a given volumetric ratio.

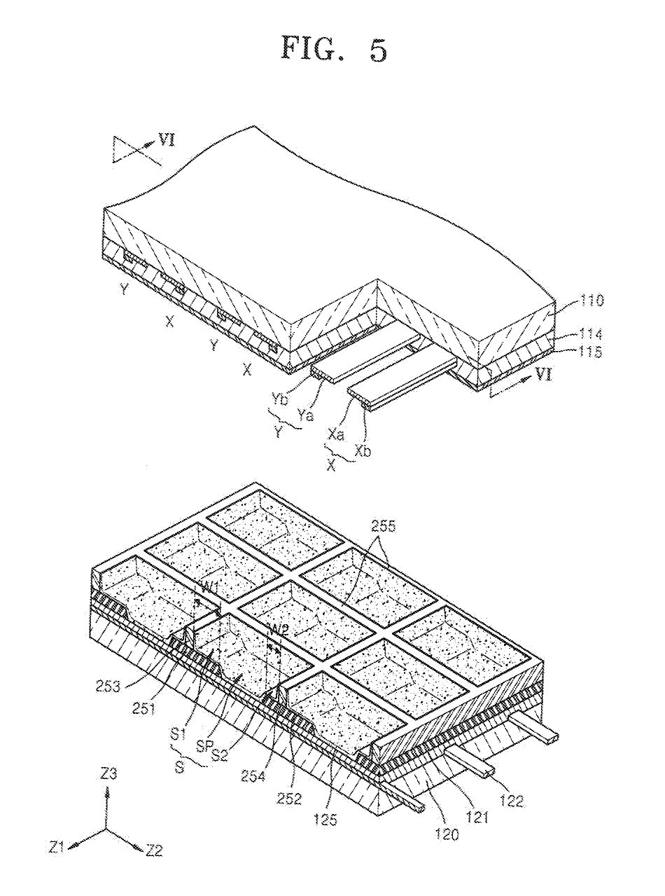

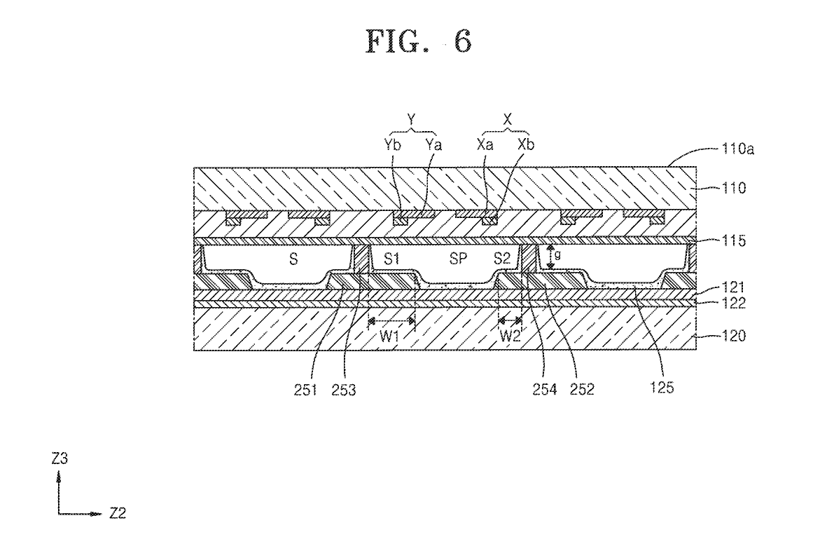

FIG. 5 is an exploded perspective view of a PDP according to another embodiment of the present invention. FIG. 6 is a vertical cross-sectional view taken along line VI-VI of FIG. 5. Referring to FIGS. 5 and 6, the first and second stepped spaces S1 and S2 are formed on both sides of a main discharge space Sp. The first width W1 is between a first barrier rib 253 defining the first stepped space 51 and an end of a first discharge enhancement layer 251. The second width W2 is between a second barrier rib 254 defining the second stepped space S2 and an end of a second discharge enhancement layer 252. The widths W1 and W2 satisfy a relationship of W1>W2. Accordingly, the first and second stepped spaces 51 and S2 are asymmetric about the center of the unit cell S. Unlike the PDP of FIG. 1, the PDP of FIG. 5 has no non-discharge space disposed between adjacent unit cells S. A third barrier rib 255 extends in a Z2 direction to cross the first and second barrier ribs 253 and 254 and define each substantially rectangular unit cell S along with the first and second barrier ribs 253 and 254.

The PDP according to the one or more embodiments of the present invention may effectively excite phosphors and improve visible light extraction efficiency by allowing support surfaces of phosphors to be formed near to discharge electrodes for performing a display discharge and also near to a display surface. Furthermore, the PDP according to the one or more embodiments of the present invention may perform an address discharge at a low voltage and obtain a sufficient voltage margin by reducing the length of an address discharge path. Moreover, the PDP according to the one or more embodiments of the present invention may reduce trapped air bubbles remaining in a phosphor layer by analyzing a process of applying phosphors and improving the structure of barrier ribs, and may improve UV-visible light conversion efficiency by uniformly forming the phosphor layer.

Although a few embodiments of the present invention have been shown and described, it would be appreciated by those skilled in the art that changes may be made in this embodiment without departing from the principles and spirit of the invention, the scope of which is defined in the claims and their equivalents.

What is claimed is:

1. A plasma display panel (PDP) comprising:
a front substrate facing a rear substrate;
a main discharge space disposed between the front substrate and the rear substrate;
first and second discharge enhancement layers disposed between the front substrate and the rear substrate, the first discharge enhancement layer being separated from the second discharge enhancement layer by the main discharge space;
first and second barrier ribs respectively formed on the first and second discharge enhancement layers and defining first and second stepped spaces along with the first and second discharge enhancement layers, the defined first and second stepped spaces being asymmetric;
a scan electrode and a common electrode inducing a mutual discharge in the main discharge space;
an address electrode generating an address discharge along with the scan electrode and extending in a direction to intersect the scan electrode;
a phosphor layer formed in at least the main discharge space; and
a discharge gas filled in the main discharge space and the first and second stepped spaces.

2. The PDP of claim 1, wherein
the first stepped space is defined by the first discharge enhancement layer and the first barrier rib which are disposed on one of the sides of the main discharge space, and
the second stepped space is defined by the second discharge enhancement layer and the second barrier rib which are disposed on the other one of the sides of the main discharge space.

3. The PDP of claim 1, wherein
a first width W1 is between the first barrier rib defining the first stepped space and an end of the first discharge enhancement layer,
a second width W2 is between the second barrier rib defining the second stepped space and an end of the second discharge enhancement layer, and
the first width W1 is greater than the second width W2.

4. The PDP of claim 1, wherein the first and second stepped spaces formed on both sides of the main discharge space form one unit cell by being connected to the main discharge space.

5. The PDP of claim 4, wherein the first stepped space, the main discharge space, and the second stepped space forming the one unit cell are repeatedly formed in a same order from one end to the other end of the PDP.

6. The PDP of claim 4, further comprising a plurality of the unit cells, wherein a non-discharge space in which no discharge occurs is formed between adjacent pairs of the unit cells.

7. The PDP of claim 6, further comprising an external-light absorbing layer formed over the non-discharge space.

8. The PDP of claim 1, further comprising a third barrier rib disposed between the front substrate and the rear substrate and extending in a direction to cross the first and second barrier ribs.

9. The PDP of claim 1, wherein the phosphor layer is disposed on the main discharge space and the first and second stepped spaces.

10. A substrate for use in a plasma display panel (PDP), the substrate comprising:
first barrier ribs and second barrier ribs;
a plurality of unit cells in which corresponding discharges are induced, each unit cell being defined between an adjacent pair of the first and second barrier ribs;
a plurality of discharge enhancement layers, each unit cell having at least one discharge enhancement layer extending partially across the unit cell and defining a raised area which is raised above a lower area of the unit cell; and
phosphor layers formed in the corresponding unit cells and which emit light according to the induced discharge.

11. The substrate of claim 10, wherein each of the discharge enhancement layers extends from one of the first and second barrier ribs to the lower area of the corresponding unit cell.

12. The substrate of claim 10, wherein, in each of the unit cells, the phosphor layer is disposed on the raised area and on the lower area.

13. The substrate of claim 10, wherein each of the unit cells includes another one of the discharge enhancement layers defining another raised area, wherein the lower area is disposed between the raised area and the another raised area.

14. The substrate of claim 13, wherein a width of the raised area is not the same as a width of the another raised area.

15. The substrate of claim 14, wherein the raised area extends from one of the first and second barrier ribs to the lower area, and the another raised area extends from the other one of the first and second barrier ribs to the lower area.

16. The substrate of claim 15, wherein, in each of the unit cells, the phosphor layer is disposed on the raised area and on the lower area.

17. The substrate of claim 16, wherein, in each of the unit cells, the phosphor layer is further disposed on the another raised area.

18. The substrate of claim 17, further comprising, between adjacent pairs of the unit cells, a non-discharge area in which a discharge is not induced.

19. The substrate of claim 17, wherein adjacent pairs of the unit cells are separated by a common one of the first and second barrier ribs.

20. A plasma display panel comprising:
a plurality of first barrier ribs and a plurality of second barrier ribs;
a plurality of unit cells configured to emit light, each of the unit cells being located between a corresponding one of the first barrier ribs and a corresponding one of the second barrier ribs, the unit cells being filled with a discharge gas;
a plurality of pairs of scan and common electrodes, each of the pairs being configured to induce a discharge in corresponding ones of the unit cells;
a plurality of discharge enhancement layers, wherein at least one of the discharge enhancement layers extends across a portion of at least one of the unit cells and forms a raised area which is raised above a lower area of the at least one of the unit cells; and
a plurality of phosphor layers in the unit cells, the phosphor layers being configured to emit light in accordance with the induced discharge.
